(19) United States
(12) Patent Application Publication
(10) Pub. No.: US 2012/0076893 A1
(43) Pub. Date: Mar. 29, 2012

(54) BAKERY PRODUCT HAVING EXCELLENT TEXTURE AND TASTE AND METHOD OF PRODUCING THE SAME

(75) Inventors: Nobuyoshi Asayama, Itami-shi (JP); Junichi Urakami, Itami-shi (JP); Yasuyuki Takaishi, Itami-shi (JP)

(73) Assignee: MATSUTANI CHEMICAL INDUSTRY CO., LTD., Itami-shi (JP)

(21) Appl. No.: 13/248,438

(22) Filed: Sep. 29, 2011

(30) Foreign Application Priority Data
Sep. 29, 2010 (JP) 2010-218974

(51) Int. Cl. A21D 2/18; A21D 13/06

(52) U.S. Cl. 426/18; 426/549

(57) ABSTRACT

An object of the present invention is to provide a bakery product which has a soft and moist texture, sweetly dissolves in the mouth, has a favorable flavor, and is well risen and a method of producing the same. Another object of the present invention is to provide a method of producing the same. By using raw material flour obtained by blending a rare sugar-containing isomerized sugar syrup or a rare sugar in wheat flour as a main raw material in the production of a bakery product, a bakery product to which softness, moistness, and a property of sweetly dissolving in the mouth is imparted is produced.

### BACKGROUND OF THE INVENTION

1. Field of the Invention

The present invention provides a bakery product which has a soft and moist texture, sweetly dissolves in the mouth (“KUTIDOKE”), has a favorable flavor, and is well risen, and also relates to a method of producing the same. The bakery product is a bakery product produced using cereal flour as a main raw material and examples thereof include a variety of bread products such as plain bread, rolls, and croissants, and cakes, biscuits, and cream puffs. The present invention particularly relates to a method of producing a bakery product such as plain bread which has a soft and moist texture and has a favorable texture such as a property of sweetly dissolving in the mouth.

2. Description of the Related Art

Recently, consumers' tastes are diversified, and there is a tendency that a new type of food free of stereotype or a food which has an unprecedented texture or a further more improved texture or flavor is demanded, and bakery products obtained using cereal flour such as wheat flour, rice flour, or starch as a main raw material such as cookies, sponge cakes, bread or rice sweets are also no exception. In particular, a new texture has been demanded for bread. Bread is one of the indispensable foods in also Japan, and a wide variety of bread products are produced every day by established manufacturers, which produce bread mainly in a large amount using machines, and retail bakery shops, which produce bread by hand at a small scale and provide the freshly baked bread, and the great number of varieties of bread in the market of bread in Japan is rarely seen in the world.

The classification of bread suitable for the current market of bread in Japan as described above is made by Japan Baking Industry Association as “practical classification of bread” as follows.

[1] Plain Bread

(1) White bread (white plain bread) : rectangular plain bread, English-type plain bread, roll-shaped plain bread, etc.

(2) Variety bread: whole wheat bread (using whole wheat flour), specialty bread (using another variety of cereal flour such as corn bread), vegetable bread (using vegetable), fruit bread (using dry fruit such as raisin bread), nut bread, etc.

(3) Table rolls, soft rolls (butter rolls, etc.), hot dog rolls, hamburger buns, etc.

[2] Hard-Baked Bread

(1) Hard bread and hard rolls: French bread (baguette, etc.), German bread (Brotchen), and Italian bread (Rosetta, pizza crust, etc.)

(2) Variety hard bread and variety hard rolls, rye bread, etc.

[3] Sweet Bread

(1) Bean-jam buns, etc.: bread obtained by baking a high-sugar content or high-fat content dough as such or after charging a filling and/or placing a topping such as Japanese-style sweet bread (bean-jam buns, cream buns, jam buns, etc.) and Western-style sweet bread (Danish pastries, croissants, etc.)

(2) Fried bread (including yeast doughnuts): bread obtained by frying bread dough as such or after charging a filling (ring doughnuts, etc.)

(3) Steamed bread: bread obtained by steaming bread dough as such or after charging a filling

[4] Other Bread (Bread which does not Belong to the Above-Described Three Categories): Muffin (English Muffin, etc.), Knäckebröd, Rusk, etc.

Conventionally, in order to impart a texture such as a soft texture or a moist texture to a bakery product such as bread, a method of blending any of various blending components and blending agents in production raw materials has been disclosed. For example, a method of adding a composition comprising an edible oil or fat, or an edible oil or fat and a sugar or a water-soluble polysaccharide, a water-soluble protein, or the like to dough for producing bread has been disclosed (JP-A-5-227873, JP-A-2003-304800, JP-A-2005-295920, JP-A-2006-288341, and JP-A-2008-67642). Further, a method of adding a protein material such as whey protein, chicken egg powder, milk protein, wheat protein, or soybean protein to wheat flour, which is a bread raw material, has been disclosed (JP-A-8-256672 and JP-A-2002-171897).

Further, a method of blending a sugar such as maltohexaose or maltopentaose in the production of bread (JP-A-2003-9757), a method of adding a bread improving agent containing a polysaccharide such as dextran or cellulose (JP-A-2001-161258 and JP-A-2006-180724), a method of blending a quality improving agent comprising a sugar obtained by blending a sugar having a glucose polymerization degree of 600 or more, a sugar having a glucose polymerization degree of from 200 to 600, and a sugar having a glucose polymerization degree of 40 or more at a specific ratio (JP-A-2007-82435), and a method of adding a thickening stabilizer such as guar gum, pectin, or locust bean gum having an average particle diameter of 20 μm or less (JP-A-2002-291396) have been also disclosed.

Further, a method of blending pregelatinized starch of wheat flour, corn, potato, or the like in raw materials in the production of bread (JP-A-59-175845, JP-A-2003-180233, and JP-A-2003-199482), a method of blending a modified starch such as etherified starch, esterified starch, crosslinked etherified starch, or crosslinked esterified starch in bread raw materials in the production of bread (JP-A-3-87135, JP-A-64-71433, and JP-A-2002-345394), and a method of blending pregelatinized crosslinked starch in bread raw materials in the production of bread (JP-A-6-125776) have been also disclosed.

As described above, there are many reports of studies on methods utilizing a polymeric substance such as a protein, an oil or fat, a starch, or a polysaccharide, however, the effect on the tastes of the products, textures imparted to the products, and the like were not always satisfying.

### SUMMARY

Since the effect on the tastes of the products, textures imparted to the products, and the like were not always satisfying in the past, a study from a different angle, for example, a study on a low-molecular weight material such as a monosaccharide, which does not impart an unpreferred texture other than a desired texture and also does not adversely affect the taste of a bakery product is needed.

In order to obtain well risen bread using wheat flour as a raw material, carbon dioxide generated by anaerobic fermentation of a fermentable sugar in bread dough by yeast is needed. In addition, the formation of gluten is indispensable. It is a matter of course that there is a bread type which is not required for adding a sugar such as conventional French bread, however, the addition of a sugar is essential for stably producing bread.

A sugar is known to have an effect of promoting fermentation by yeast and stabilizing dough. In addition, a sugar forms various aromatic substances and affects a flavor in the process of producing bread. Therefore, by selecting a sugar to be used, the sugar can contribute to the improvement of the quality. Also in the process of baking, caramelization and the Maillard reaction are caused, which also contribute to the impartment of a flavor.

It is considered that the addition of a sugar by changing the type or amount of the sugar as described above also affects the baking temperature or the like, which results in imparting a water-retaining property, delaying aging, prolonging storage stability, and so on. Other than these, by the addition of a sugar, the yield of bread is increased, the gelatinization of starch is delayed, and the degeneration of protein is delayed, and therefore, the following improvement is expected: the whole inner part becomes soft, the soft texture is improved, a sweet taste is imparted, a taste is improved, and a browning property is improved.

As an example of studying D-psicose which is one of the rare sugars considered to exist in a small amount in nature, the interaction of D-psicose with albumin has been reported (Journal of Bioscience and Bioengineering, Vol. 86, No. 9, pp. 434-436 (2008)). This report describes that the interaction contributes to the improvement of heat-induced gelation and the like. Also in the process of producing a bakery product, it is expected that an unexpected effect of the interaction of such a low-molecular weight monosaccharide may be obtained.

Accordingly, an object which the present invention is to achieve is to provide a bakery product which has a soft and moist texture, sweetly dissolves in the mouth, has a favorable flavor, and is well risen, and another object which the present invention is to achieve is to provide a method of producing the same. The bakery product is a bakery product produced using cereal flour such as wheat flour or starch as a main raw material and examples thereof include cookies, sponge cakes, bread, and rice sweets. In particular, an object of the present invention is to provide a bakery product such as plain bread which has a soft and moist texture and has a favorable texture such as a property of sweetly dissolving in the mouth.

In order to achieve the above objects, the present inventors made intensive studies, and as a result, they found that by using raw material flour obtained by blending a rare sugar-containing isomerized sugar syrup or a rare sugar in the production of a bakery product such as plain bread, a bakery product to which softness, moistness, and a property of sweetly dissolving in the mouth is imparted can be produced, and thus completed the present invention.

That is, a gist of the present invention is a method of producing a bakery product according to any one of the following (1) to (6).

(1) A method of producing a bakery product, characterized by using raw material flour obtained by blending a rare sugar or a rare sugar-containing isomerized sugar syrup in the production of a bakery product using cereal flour as a main raw material, thereby imparting softness, moistness, and a property of sweetly dissolving in the mouth to the produced bakery product.

(2) The method of producing a bakery product according to the above (1), wherein the rare sugar-containing isomerized sugar syrup or the rare sugar is blended in an amount of from 0.1 to 100 parts by mass based on 100 parts by mass of the main raw material flour.

(3) The method of producing a bakery product according to the above (1), wherein the rare sugar-containing isomerized sugar syrup contains sugars other than D-glucose and D-fructose in an amount of less than 60% by mass, and is obtained by isomerizing one or more of the members selected from the group consisting of D-glucose, D-fructose, and an isomerized corn syrup with 0.005 mol/l or more of an alkali.

(4) The method of producing a bakery product according to the above (1), wherein the rare sugar is at least D-psicose and/or D-allose.

(5) The method of producing a bakery product according to the above (1), wherein the bakery product includes a step of assimilating a sugar by yeast.

(6) The method of producing a bakery product according to the above (1), wherein the bakery product is plain bread.

Further, another gist of the present invention is a bakery product according to the following (7).

(7) A bakery product produced by the production method according to the above (1), which has softness, and moistness, and a property of sweetly dissolving in the mouth.

According to the present invention, a bakery product obtained using cereal flour such as wheat flour as a main raw material, which has a soft and moist texture, sweetly dissolves in the mouth, has a favorable flavor, and is well risen can be provided.

A rare sugar, (particularly D-psicose and/or D-allose) is used in a variety of applications (for example, for restriction of calorie intake in the case of obesity or the like, for suppression of increase in blood glucose level due to a disease such as diabetes, etc.) such as a low-calorie sweetener, and has a characteristic as a low-calorie sweetener. By blending such a rare sugar and using the method of producing a bakery product according to the present invention, a bakery product such as plain bread, which has a soft and moist texture, sweetly dissolves in the mouth, has a favorable flavor, and is well risen can be provided.

### DETAILED DESCRIPTION

In the present invention, the bakery product is a product obtained by baking a starch-based raw material such as wheat flour, and examples thereof include variety of bread products such as plain bread, rolls, and croissants, and cakes, biscuits, and cream puffs. The bakery product is prepared by using raw material flour containing cereal flour such as wheat flour as a main raw material, and adding thereto, yeast (or baking powder), salt, and water, and if necessary, an auxiliary material, optionally subjecting the resulting mixture to a fermentation step to obtain ordinary bakery dough, and then, performing a heating treatment such as baking, frying, or steaming of the dough. As the cereal flour which is the main raw material flour according to the present invention, wheat flour can be mainly used. However, other than this, the cereal flour include rice flour, starch (for example, corn starch, waxy corn starch, potato starch, rice starch, glutinous rice starch, tapioca starch, wheat starch, sago starch, sweet potato starch, etc.), modified starch (for example, crosslinked starch, acetylated starch, etherified starch, acetylated crosslinked starch, etherified crosslinked starch, oxidized starch, octenyl succinate starch, etc.), acid-treated starch, starch roasted in the presence of an acid, whole wheat flour, corn flour, rye flour, and the like. Further, other than the above-described raw material flour, cereal other than wheat, for example, whole wheat flour, rye, rice, corn, barley, Japanese barnyard millet, foxtail millet, proso millet, sprouted brown rice, black rice, red rice, soybeans, red beans, amaranth, quinoa, or the like may be mixed in the raw material flour. The composition of the raw material flour is not particularly limited, and commonly used raw materials can be used.

Specifically, the present invention provides (1) a method of producing a bakery product, comprising using raw material flour obtained by blending a rare sugar-containing isomerized sugar syrup or a rare sugar in wheat flour as a main raw material in the production of a bakery product, thereby imparting softness, moistness, and a property of sweetly dissolving in the mouth to the produced bakery product; and (2) the method of producing a bakery product according to the above (1), wherein the rare sugar-containing isomerized sugar syrup or the rare sugar is blended in an amount of from 0.1 to 100 parts by mass based on 100 parts by mass of the main raw material flour. The method of producing a bakery product according to the present invention is applied to the production of a bakery product such as plain bread and can impart softness, moistness, and a property of sweetly dissolving in the mouth to the bakery product.

Further, a bakery product is preferably made with the method of producing a bakery product including a production process including a step of assimilating a sugar using yeast.

The rare sugar constituting the present invention is a “sugar that rarely exists in nature” according to the definition of International Society of Rare Sugars, and is a monosaccharide that exists only in a small amount in nature. According to the present invention, such a rare sugar or the contained rare sugar is incorporated in the bakery product in an amount of from 0.1 to 100 parts by mass based on 100 parts by mass of wheat flour which is the main raw material.

The “rare sugar” in the present invention is a “sugar that rarely exists in nature” according to the definition of International Society of Rare Sugars, and is a monosaccharide that exists only in a small amount in nature. In addition, the mass production thereof is difficult, and therefore, it is considered that there are a lot of unknown properties of a rare sugar remaining to be elucidated.

As a hexose, there are 16 types of aldoses including L-allose, L-gulose, L-glucose, L-galactose, L-altrose, L-idose, L-mannose, L-talose, D-talose, D-mannose, D-idose, D-altrose, D-galactose, D-glucose, D-gulose, and D-allose; and 8 types of ketoses including L-psicose, L-sorbose, L-fructose, L-tagatose, D-tagatose, D-fructose, D-sorbose, and D-psicose. Among these hexoses, as a monosaccharide that exists in a large amount in nature, there are 7 types of monosaccharides including D-glucose, D-fructose, D-galactose, D-mannose, D-ribose, D-xylose, and L-arabinose, and all of the other monosaccharides are rare sugars.

The “rare sugar” in the present invention is not limited to these, and includes derivatives thereof, and also, sugar alcohols thereof, uronic acids thereof, amino sugars thereof, and the like can be exemplified.

Among the above-described rare sugars, D-psicose is a rare sugar which can be produced in a large amount at present. As a method of obtaining D-psicose, a production method in which fructose is treated with an enzyme (epimerase) to obtain D-psicose is generally used at present, however, D-psicose in the present invention is not limited thereto, and one obtained by a production method utilizing a microorganism which produces the enzyme or one extracted from a natural substance may be used, or a natural substance containing D-psicose may be used as such, or one obtained by isomerization through a chemical treatment method may be used. Incidentally, a method of purifying D-psicose utilizing an enzyme is disclosed in, for example, JP-A-4-91744 or the like.

On the other hand, D-allose is one of the rare sugars which have been tried to be produced in a large amount. As a method of obtaining D-allose, a method of synthesizing it from D-psicose using L-rhamnose isomerase (Journal of Fermentation and Bioengineering, Vol. 85, pp. 539 to 41 (1998)), a method of obtaining it by allowing D-xylose isomerase to act on a solution containing D-psicose (JP-A-2002-17392), and the like have been disclosed. However, D-allose in the present invention is not limited thereto, and D-allose obtained by any method, for example, one obtained by isomerization through a chemical treatment method or the like can be used.

The rare sugar-containing isomerized sugar syrup in the present invention is an isomerized sugar syrup containing any of the above-described rare sugars, and the isomerized sugar syrup is a liquid sugar containing glucose and fructose as main components. As a method of obtaining a rare sugar, several examples are already described, however, at present, there is almost no method with which a rare sugar can be obtained in a large amount at low cost. As a result of intensive studies, the present inventors succeeded in obtaining a rare sugar-containing isomerized sugar syrup which contains a rare sugar in an amount of about 10% by mass at low cost by a relatively simple reaction method in which an isomerized sugar syrup is isomerized with an alkali (International Patent Application No. PCT/JP2010/5536). in the course of completing the present invention, it was found that in the sugar composition of the rare sugar-containing isomerized sugar syrup studied, the identified rare sugars are D-psicose (0.5 to 17% by mass) and D-allose (0.2 to 10% by mass), and other than these, also unidentified rare sugars exist, and the rare sugars according to the present invention also include these unidentified rare sugars. Further, it is found that the rare sugar-containing isomerized sugar syrup contains D-mannose, which is not a rare sugar, in an amount of 0.5% or more. Examples described in international Patent Application No. PCT/JP2010/5536 are as follows.

<Reaction of 5% isomerized sugar syrup using strongly basic ion exchange resin> An isomerized sugar syrup was prepared at 5% (w/v) with a 0.1 M NaOH solution. 1100 mL of the resulting solution was sequentially passed through 45 ml of a strongly basic ion exchange resin and 26 ml of a strongly acidic ion exchange resin at a temperature of 60° C. and at a flow rate of 0.8 mL/min (strongly basic ion exchange resin: Amberlite IRA 900J OH, strongly acidic ion exchange resin: Amberlite 200 CT (H-type), column length: 30 cm, column inner diameter: 1.5 cm). Sampling was performed by collecting the reaction solution eluted over time from the column at this time, and the reaction solution was analyzed by HPLC (detector: RI, column: MCI GEL CK 08EC, Mitsubishi Chemical Corporation). After the solution was passed through the column (1000 mL), a mixed sugar liquid containing the following sugars (each numerical value in the parenthesis indicates the percentage of sugar (s) to the total amount of sugars): D-glucose (34.3%), D-mannose+D-sorbose+D-altrose (12.4%), D-fructose (25.8%), D-allose (4.1%), and D-psicose (6.3%) was obtained.

<Reaction of 40% isomerized sugar syrup using strongly basic ion exchange resin> An isomerized sugar syrup was prepared at 40% (w/v) with a 0.1 M NaOH solution. 1100 mL of the resulting solution was sequentially passed through 45 ml of a strongly basic ion exchange resin and 26 ml of a strongly acidic ion exchange resin at a temperature of 60° C. and at a flow rate of 0.8 mL/min (strongly basic ion exchange resin: Amberlite IRA 900J OH, strongly acidic ion exchange resin: Amberlite 200 CT (H-type), column length: 30 cm, column inner diameter: 1.5 cm). Sampling was performed by collecting the reaction solution eluted over time from the column at this time, and the reaction solution was analyzed by HPLC (detector: RI, column: MCI GEL CK O8EC, Mitsubishi Chemical Corporation). After the solution was passed through the column (1000 mL), a mixed sugar liquid containing the following sugars (each numerical value in the parenthesis indicates the percentage of sugar(s) to the total amount of sugars): D-glucose (46.2%), D-mannose+D-sorbose+D-altrose (6.3%), D-fructose (32.8%), D-allose (2.0%), and D-psicose (4.8%) was obtained.

On the other hand, if the isomerization reaction is allowed to proceed until the concentration of D-glucose and D-fructose is reduced to about 40% by mass, browning of the isomerized sugar proceeds significantly, and therefore, it is difficult to industrially apply the resulting product. Accordingly, the content of sugars other than D-glucose and D-fructose is preferably less than 60% by mass.

The rare sugar-containing isomerized sugar syrup in the present invention is not limited to those obtained by the above-described method, and one obtained by another method may be used, or the rare sugars contained therein are not limited only to D-psicose and D-allose which have been identified so far.

The bakery product or the like having an improved texture and/or taste or the like according to the present invention should satisfy the requirement that the product contains at least D-allose and/or D-psicose in an appropriate amount. However, by incorporating a rare sugar other than D-allose and D-psicose, or a sugar, a high-intensity sweetener, or the like within a range that does not have an adverse effect on the quality, a bakery product which has a better texture, taste or the like can be obtained.

In the case of using a rare sugar-containing isomerized sugar syrup which is obtained by isomerizing an isomerized sugar syrup, fructose, or glucose, by changing a reaction condition or the like for the isomerization, for example, by changing an assimilable sugar such as glucose, fructose, or D-mannose, or by changing a concentration of an alkali, a reaction time, or a reaction substrate, a non-assimilable sugar such as D-allose, D-psicose, D-sorbose, or D-tagatose can be incorporated in the isomerized sugar syrup. It is also possible to incorporate a variety of sugars in bread by using an L-form sugar obtained by using D-galactose as a substrate. The type or amount of a rare sugar to be generated by the isomerization varies, and therefore, it is possible to improve the flavor and taste by utilizing the difference in the reaction condition. In other words, since the type or amount of a rare sugar to be generated by the isomerization varies, the reaction condition not only affects whether or not the sugar itself is assimilable, but also affects whether or not fermentation is allowed to continuously proceed without inhibiting the assimilation of maltose generated from wheat starch during the fermentation of dough and so on, and contributes to the improvement of the flavor and taste of the product after baking.

In the case of using a rare sugar-containing isomerized sugar syrup, when it is added during the fermentation step of the bakery product, the isomerized sugar syrup (glucose and fructose), D-mannose, and the like are assimilated to some extent by yeast, however, a rare sugar portion is not assimilated by yeast and remains in the bakery product as such. That is, since the rare sugar-containing isomerized sugar syrup contains assimilable sugars and non-assimilable sugars, the ratio of the non-assimilable sugars is increased by allowing the yeast to assimilate the assimilable sugars in the fermentation step using the yeast, the texture and taste can be improved, whereby a bakery product in which a soft and moist texture, a property of sweetly dissolving in the mouth, a flavor, and a rising property are improved can be produced.

Also, by changing the method of producing bread, a different effect can be obtained. For example, even in the case of using a sponge dough method, a rare sugar-containing isomerized sugar syrup is incorporated in sponge, and fermentation of an assimilable sugar is promoted by long-term fermentation, and an effect of the remaining non-assimilable sugar can also be expected. Further, in the case of using a straight dough method, a pre-ferment dough method, or the like, it is also possible to obtain a favorable property by placing yeast and a rare sugar-containing isomerized sugar syrup at a preferred temperature for a preferred time period to adjust the amount of the remaining assimilable sugar.

In the method of producing a bakery product, the time when the raw material containing a rare sugar is added depends on the type of a bakery product and/or the production method thereof. For example, in the case of bread, any of a straight dough method, a pre-ferment dough method, a continuous production method, a sponge dough method may be used, and the raw material containing a rare sugar may be added at either time when sponge dough is prepared or when main dough is prepared. In the case of a bakery product other than bread, the raw material containing a rare sugar can be added at any time until dough is baked.

In the above-described cases, it is considered that monosaccharides having a different structure interact with one another in various steps such as a step of kneading the monosaccharides and wheat flour, a step of fermentation, and a step of giving dough a rest such as a benching time and have an effect on various final products.

In the method of producing a bakery product or the like having an improved texture and/or taste or the like according to the present invention, the using amount of the raw material containing a rare sugar necessary for improving the property is not particularly limited as long as a desired effect can be obtained, however, there is a preferred concentration of the raw material containing a rare sugar according to the type of a bakery product.

For example, in the case of a bakery product which originally has almost no sweetness such as plain bread or French bread, by adding the rare sugar-containing isomerized sugar syrup or the rare sugar in an amount of from 0.1 to 10% by mass based on 100% by mass of the main raw material flour, the effect of improving the texture and taste can be effectively obtained. If the amount of the added sugar in the final product is less than 0.1% by mass, the effect of improving the quality of taste is not sufficient, and therefore, the sugar is added in amount of 0.1% by mass or more, preferably 0.5% by mass or more. Meanwhile, if the amount thereof exceeds 10% by mass, although there is no problem for a bakery product or the like which originally has high sweetness such as sweet bread, high sweetness is imparted to a bakery product other than the sweet bread to deteriorate the overall taste balance, and also from the economic point of view, the amount thereof is preferably determined to be up to 10% by mass.

In the case of a bakery product or the like which originally has high sweetness such as sweet bread, by adding the rare sugar-containing isomerized sugar syrup or the rare sugar in an amount of from 1 to 30% by mass based on 100% by mass of the main raw material flour, the effect of improving the texture and taste can be effectively obtained. Further, in the case of a sponge cake, by adding the rare sugar-containing isomerized sugar syrup or the rare sugar in an amount of from 5 to 160% by mass based on 100% by mass of the raw material flour, the effect of improving the texture and taste can be effectively obtained.

Further, the effect of the present invention can be obtained in any type of bakery product, however, the rare sugar-containing isomerized sugar syrup and/or the rare sugar contains a sugar which is not assimilated and has lower calories as compared with an ordinary sugar, and therefore, in a low-calorie or low-sugar bakery product, the effect of improving the texture and taste of the present invention can be further brought about.

The thus obtained bakery product has an excellent texture and taste, and moreover, in the case where the present invention is applied to a low-calorie bakery product, both health aspect and hedonic aspect can be achieved, and the present invention has a very high value from the viewpoint of industrial application.

The present invention provides a method of producing a bakery product comprising using raw material flour obtained by blending a rare sugar-containing isomerized sugar syrup and/or a rare sugar in wheat flour as a main raw material in the production of a bakery product, thereby imparting softness, moistness, and a property of sweetly dissolving in the mouth to the produced bakery product.

The bakery product according to the present invention is prepared by using cereal flour such as wheat flour as a main raw material, and adding thereto, yeast (or baking powder), salt, and water, and if necessary, an auxiliary material, optionally subjecting the resulting mixture to a fermentation step to obtain an ordinary bakery dough, and then, performing a heating treatment such as baking, frying, or steaming of the dough. Other than the above-described raw material flour, cereal other then wheat, for example, whole wheat flour, rye, rice, corn, barley, Japanese barnyard millet, foxtail millet, proso millet, sprouted brown rice, black rice, red rice, soybeans, red beans, amaranth, quinoa, or the like may be mixed in the raw material flour.

Specific examples of the bakery product include plain bread such as Pullman bread and English plain bread, French bread such as baguette and parisien, sweet bread, buns, a variety of rolls such as table rolls, yeast doughnuts, cake doughnuts, Chinese-style steamed pork buns, cakes such as sponge cakes, and cream puff dough.

Incidentally, the auxiliary material as used herein is an auxiliary material to be generally used in the production of a bakery product or an auxiliary material to be used according to the type of a bakery product, a desired quality, or the like, and specific examples thereof include sugars such as sucrose, glucose, an isomerized sugar syrup, oligosaccharide, and a reduced starch decomposition product, milk products such as skim milk powder and whole milk powder, oils and fats such as shortening, margarine, butter, and an emulsified oil or fat, emulsifying agents such as glycerin fatty acid ester, sucrose fatty acid ester, and calcium stearoyl lactate, spices such as cinnamon and basil, Western liquors such as brandy and rum, dry fruit such as raison and dry cherry, nuts such as almond and peanut, enzymes such as α-amylase, β-amylase, glucoamylase, protease, lipase, xylanase, hemicellulase, and glucose oxidase, flavorings such as vanilla essence, artificial sweeteners such as aspartame, dietary fibers such as pectin, a guar gum decomposition product, agarose, glucomannan, polydextrose, sodium alginate, cellulose, hemicelluloses, lignin, chitin, chitosan, and indigestible dextrin, resistant starch, active gluten, and cocoa powder.

The method of producing a bakery product according to the present invention comprises using raw material flour obtained by blending a rare sugar-containing isomerized sugar syrup and/or a rare sugar in wheat flour as a main raw material. As for the blending ratios of these materials, the rare sugar-containing isomerized sugar syrup or the rare sugar is blended in wheat flour in an amount of from 0.1 to 100 parts by mass based on 50 to 100 parts by mass of wheat flour (the resulting mixture is referred to as “raw material flour”).

As the wheat flour to be used in the present invention, wheat flour which is used in the production of ordinary bread is used, and if necessary, part of wheat flour can be replaced by whole wheat flour, rye flour, corn flour, graham flour, rice flour, barley, Japanese barnyard millet, foxtail millet, proso millet, sprouted brown rice, black rice, red rice, soybeans, red beans, amaranth, quinoa, or the like. The replacement amount may be any amount, however, preferably, 5 to 20% by weight of the amount of wheat flour in the raw material flour can be replaced.

In order to improve the texture and taste, starch can also be added. As the type of starch, commercially available starch, for example, potato starch, tapioca starch, wheat starch, corn starch, waxy corn starch, rice starch, glutinous rice starch, sago starch, sweet potato starch, or the like can be used. Further, a modified starch may be used. The modified starch is starch obtained by modifying commercially available untreated starch, and specific examples of the modified starch include acid-treated starch, sodium hypochlorite-treated starch, crosslinked starch, etherified starch, esterified starch, crosslinked etherified starch, and crosslinked esterified starch. Examples of the cereal flour include wheat flour, rice flour, and corn flour. Further, oxidized starch, oxidized acetyl starch, pregelatinized starch, phosphate-crosslinked starch, hydroxypropyl starch, octenyl succinate starch, or the like obtained by using the above-described starch may also be used.

Examples of the starch to be used as a raw material of the pregelatinized starch include commercially available untreated starch such as corn starch, wheat starch, potato starch, rice starch, glutinous rice starch, high-amylose corn starch, tapioca starch, waxy corn starch, pea starch, and mung bean starch. Further, the above-described starch, modified starch, and cereal flour can be used in combination.

As the method of producing bread according to the present invention, any method which is generally used such as a sponge method, a straight dough method, a Tang zhong method, or the like can be used. In such a production method, in raw material flour, required materials other than raw material flour such as salt, yeast, yeast food, sucrose, and an oil or fat are blended, and water is added thereto, followed by kneading, and then, according to a conventional procedure, steps of fermentation, division, rounding, resting, shaping, placement in a mold, final proofing, and so on are performed, followed by a heating treatment such as baking, steaming or frying, whereby bread is obtained. Further, the raw material flour of the present invention can be used in the form of a premix obtained by mixing the raw materials in advance, or the respective raw materials may be added and mixed when bread is produced.

Further, by adopting a technique of frozen dough using freeze-tolerant yeast, an oxidant (such as ascorbic acid), a starch degrading enzyme (such as glucoamylase), or the like, the present invention can be applied to frozen dough. In the case where a physiological function is desired to be imparted or nutrition is desired to be enhanced, a component having a desired function, for example, any of a variety of dietary fibers, a variety of oligosaccharides, polyvalent unsaturated fatty acids, peptides, glycosides, vitamins, polyphenols, minerals, and the like can be added as needed.

In order to increase sweetness, a high-intensity sweetener such as acesulfame potassium, aspartame, stevia, or sucralose, a sugar alcohol such as erythritol, sorbitol, maltitol, or xylitol may be used.

Hereinafter, the present invention will be more specifically described with reference to Examples, however, the technical scope of the present invention is not limited to these examples.

In the Examples and Reference examples, the “part” indicates “part by mass”. As an isomerized sugar syrup and a rare sugar-containing isomerized sugar syrup, a solution containing an isomerized sugar syrup or a rare sugar-containing isomerized sugar syrup in an amount of 70% by weight was used.

A rare sugar-containing isomerized sugar syrup used in Examples 1 to 3 was produced by the following method. As an isomerized sugar syrup used in the following Examples, Fuifructo F-100 (glucose:fructose=51:43) was used.

First, a commercially available isomerized sugar syrup was prepared at 30% (w/v) with a 0.1 M NaOH solution. Then, the resulting solution was passed through a strongly basic ion exchange resin (resin: Amberlite IRA 900J [OH]) after being packed at a temperature of 60° C. and at an SV (space velocity=flow amount (L)/time (h)/resin amount (L)) of 1. Subsequently, an eluted sugar liquid was purified and condensed using an ion exchange resin according to a conventional procedure, whereby an isomerized sugar syrup containing a rare sugar was obtained.

Sampling was performed by collecting the reaction solution eluted over time from the column at this time, and the reaction solution was analyzed by HPLC (detector: RI, column: MCI GEL CK 08EC, Mitsubishi Chemical Corporation). The peak area ratios corresponding to respective sugars were approximately as follows: D-glucose:D-fructose:D-psicose: rare sugars containing D-allose=44:32:6:6.

### EXAMPLE 1

By using wheat flour and an isomerized sugar syrup (Comparative example 1) or a rare sugar-containing isomerized sugar syrup (Example 1), English-type plain bread was produced by a sponge method according to the following compositional ratios. The compositional ratios are shown in Table 1, the production conditions are shown in Table 2, the evaluation criteria are shown in Table 3, and the results of evaluation performed based on the evaluation criteria shown in Table 3 are shown in Table 4.

TABLE 1
Compositional ratios for plain bread

| | | | Comparative | |
|---|---|---|---|---|
| | Raw material | Control | example 1 | Example 1 |
| Sponge | Hard wheat flour*¹ | 70 | 70 | 70 |
| | Yeast*² | 2 | 2 | 2 |
| | Yeast food*³ | 0.1 | 0.1 | 0.1 |
| | Water | 42 | 42 | 42 |
| Main dough | Hard wheat flour | 30 | 30 | 30 |
| | Sucrose | 6.5 | 3 | 3 |
| | Rare sugar-containing | — | — | 5 |
| | isomerized sugar syrup | | | |
| | Fujifructo F-100 | — | 5 | — |
| | Salt | 2 | 2 | 2 |
| | Skim milk powder*⁴ | 2 | 2 | 2 |
| | Water | 24 | 24 | 24 |
| | Shortening*⁵ | 5 | 5 | 5 |

*¹“Mirion”, Nisshin Flour Milling Inc.
*²“Oriental Yeast”, Oriental Yeast Co., Ltd.
*³“C Oriental Food”, Oriental Yeast Co., Ltd.
*⁴“Hokkaido Skim Milk”, Snow Brand Milk Products Co., Ltd.
*⁵“Shortening”, Snow Brand Milk Products Co., Ltd.

TABLE 2

Production conditions
Temperature of sponge after completion of kneading: 24° C.
Fermentation time for sponge: 4 hours
Temperature of main dough after completion of kneading: 28° C.
Floor time: 20 minutes
Division: 275 g × 2
Bench time: 20 minutes
Final proof: 60 minutes
Baking temperature: upper heat: 180° C., lower heat: 205° C.
Baking time: 28 minutes

TABLE 3
Evaluation items and criteria for test of produced bread

| Evaluation | | |
|---|---|---|
| item | Score | Evaluation criteria |
| Shape | 5 | The bread is stretched extremely favorably and is well proportioned. The bread |
| | | is uniformly browned and has a shiny surface. |
| | 4 | The bread is stretched favorably and is well proportioned. The bread is |
| | | uniformly browned and the color is favorable. |
| | 3 | The bread is stretched slightly. The bread is browned slightly poorly and the |
| | | color is slightly light. |
| | 2 | The bread is stretched somewhat poorly. The bread is browned somewhat |
| | | poorly. |
| | 1 | The bread is stretched poorly and adjacent dough pieces are joined poorly. The |
| | | bread is browned extremely poorly and unevenly. |
| Flavor | 5 | Fermentation smell is extremely well balanced in terms of flavor of sweetness, |
| | | alcohol smell, and acid smell. |
| | 4 | Fermentation smell is well balanced in terms of flavor of sweetness, alcohol smell, |
| | | and acid smell. |
| | 3 | Flavor balance is slightly poor, and the bread has yeast smell and flour smell. |
| | | The bread has almost no strange taste or strange smell. |
| | 2 | Flavor balance is poor, and the bread has yeast smell and flour smell. The |
| | | bread has some strange taste and strange smell. |
| | 1 | Flavor balance is extremely poor, and the bread has yeast smell and flour smell. |
| | | Also, the bread has strange taste and strange smell. |
| Moistness | 5 | The bread is extremely moist. |
| | 4 | The bread is moist. |
| | 3 | The bread is somewhat moist. The bread has almost no dry texture or unmoist |
| | | texture. |
| | 2 | The bread is somewhat not moist. The bread has a slightly dry texture or |
| | | unmoist texture. |
| | 1 | The bread is not moist. The bread has a dry texture and an unmoist texture. |
| Softness | 5 | The bread is extremely soft. |
| | 4 | The bread is soft. |
| | 3 | The bread is somewhat soft. The bread has almost no hard texture or elastic |
| | | texture (the hard or elastic texture does not bother). |
| | 2 | The bread somewhat lacks softness. The bread is slightly hard or has an elastic |
| | | texture. |
| | 1 | The bread lacks softness. The bread is hard or has a strong elastic texture, and |
| | | has a heavy texture. |
| Property of | 5 | The bread extremely sweetly dissolves in the mouth. |
| sweetly | 4 | The bread sweetly dissolves in the mouth. |
| dissolving in | 3 | The bread almost sweetly dissolves in the mouth. There is almost no sense of |
| the mouth | | lump or dumpling in the mouth. The bread does not remain in the mouth. |
| | 2 | The bread dissolves in the mouth somewhat poorly. The bread slightly turns into |
| | | a lump or dumpling in the mouth, or the bread remains a little in the mouth. |
| | 1 | The bread dissolves in the mouth poorly. The bread turns into a lump or |
| | | dumpling in the mouth, or the bread remains in the mouth. |

TABLE 4
Results

| | | Comparative | |
|---|---|---|---|
| | Control | example 1 | Example 1 |
| Shape | 5 | 4 | 4 |
| Flavor | 5 | 5 | 5 |
| Moistness | 3 | 5 | 5 |
| Softness | 3 | 2 | 3 |
| Property of sweetly dissolving | 3 | 2 | 4 |
| in the mouth | | | |

The obtained English-type plain bread was comparable to an ordinary product with respect to shape, inner part, and outer appearance, and had a moist and soft texture and sweetly dissolved in the mouth.

### EXAMPLE 2

By using wheat flour and an isomerized sugar syrup (Comparative example 2) or a rare sugar-containing isomerized sugar syrup (Example 2), a butter roll was produced by a sponge method according to the following compositional ratios. The compositional ratios are shown in Table 5, the production conditions are shown in Table 6, and the results of evaluation are shown in Table 7. As the evaluation criteria, those shown in Table 3 were used.

TABLE 5
Compositional ratios for butter roll

| | | | Comparative | |
|---|---|---|---|---|
| | Raw material | Control | example 1 | Example 1 |
| Sponge | Hard wheat flour*¹ | 70 | 70 | 70 |
| | Sucrose | 3 | 3 | 3 |
| | Whole egg | 10 | 10 | 10 |
| | Yeast*² | 2.5 | 2.5 | 2.5 |
| | Yeast food*³ | 0.1 | 0.1 | 0.1 |
| | Water | 32 | 32 | 32 |
| Main dough | Hard wheat flour | 30 | 30 | 30 |
| | Sucrose | 11 | 4 | 4 |
| | Rare sugar-containing | — | — | 10 |
| | isomerized sugar syrup | | | |
| | Isomerized sugar syrup | — | 10 | — |
| | Salt | 1.6 | 1.6 | 1.6 |
| | Skim milk powder*⁴ | 3 | 3 | 3 |
| | Water | 22 | 19 | 19 |
| | Margarine*⁶ | 10 | 10 | 10 |

*¹ to ⁴The product names are the same as those shown in Table 1.
*⁶“Panteon Select M”, Miyoshi Oil & Fat Co., Ltd.

TABLE 6

Production conditions
Temperature of sponge after completion of kneading: 26° C.
Fermentation time for sponge: 2.5 hours
Temperature of main dough after completion of kneading: 28° C.
Floor time: 20 minutes
Division: 40 g
Bench time: 20 minutes
Final proof: 50 minutes
Baking temperature: upper heat: 190° C., lower heat: 175° C.
Baking time: 8 minutes

TABLE 7
Results of butter roll

| | | Comparative | |
|---|---|---|---|
| | Control | example 2 | Example 2 |
| Shape | 5 | 4 | 4 |
| Flavor | 5 | 5 | 5 |
| Moistness | 3 | 4 | 4 |
| Softness | 3 | 4 | 5 |
| Property of sweetly dissolving | 3 | 2 | 4 |
| in the mouth | | | |

The obtained butter roll was comparable to an ordinary product with respect to shape, inner part, and outer appearance, and had a moist and soft texture and sweetly disolved in the mouth.

### EXAMPLES 3 AND 4

By using wheat flour and an isomerized sugar syrup (Comparative examples 3 and 4) or a rare sugar-containing isomerized sugar syrup (Examples 3 and 4), a sponge cake was produced according to the following compositional ratios. The compositional ratios are shown in Table 8, the production conditions are shown in Table 9, the evaluation criteria are shown in Table 10, and the evaluation results are shown in Table 11.

TABLE 8
Compositional ratios for sponge cake

| | | Comparative | Comparative | | |
|---|---|---|---|---|---|
| Raw material | Control | example 3 | example 4 | Example 3 | Example 4 |
| Weak wheat flour*⁷ | 100 | 100 | 100 | 100 | 100 |
| Whole egg | 140 | 140 | 140 | 140 | 140 |
| Water | 18 | 11.3 | 4 | 11.3 | 4 |
| Foamable emulsified oil or fat*⁸ | 15 | 15 | 15 | 15 | 15 |
| Sucrose | 120 | 100 | 78 | 100 | 78 |
| Rare sugar-containing isomerized sugar syrup | — | — | — | 28.5 | 60 |
| Fujifructo F-100 | — | 28.5 | 60 | — | — |

*⁷“Violet”, Nisshin Flour Milling Inc.
*⁸“Performa G”, Tsukishima Foods Industry Co.. Ltd.

The production conditions for a sponge cake using an “all-in one mix” method are shown in Table 9.

TABLE 9

Production conditions
Specific gravity of dough: 0.45
Baking time: 30 minutes
Baking temperature: upper and lower heat: 180° C.

TABLE 10
Evaluation items and criteria for test of sponge cake

| Evaluation item | Score | Evaluation criteria |
|---|---|---|
| Shape | 5 | The surface is extremely flat, and no dent is observed. |
| | 4 | The surface is flat, and no dent is observed. |
| | 3 | A dent is slightly observed on the surface, but the surface is almost flat. |
| | 2 | A dent is observed on the surface and the surface is somewhat not flat. |
| | 1 | A dent on the surface is significant, and the shape is extremely poor. |
| Baked color | 5 | The baked color is extremely light and very favorable. |
| | 4 | The baked color is light and favorable. |
| | 3 | The baked color is moderate. |
| | 2 | The baked color is slightly dark and slightly poor. |
| | 1 | The baked color is extremely dark and poor. |
| Texture | 5 | The sponge cake has an extremely soft, moist, and favorable texture. |
| | 4 | The sponge cake has a soft and nearly moist texture. |
| | 3 | The sponge cake has a slightly soft and some moist texture. |
| | 2 | The sponge cake has a slightly hard and somewhat unmoist texture. |
| | 1 | The sponge cake has a hard. unmoist, and unfavorable texture. |
| Property of | 5 | The sponge cake is soft when it is put into the mouth and extremely sweetly |
| sweetly | | dissolves in the mouth. |
| dissolving in | 4 | The sponge cake is somewhat soft when it is put into the mouth and sweetly |
| the mouth | | dissolves in the mouth. |
| | 3 | The sponge cake has a slightly glutinous texture and somewhat poorly |
| | | dissolves in the mouth. |
| | 2 | The sponge cake has a glutinous texture and poorly dissolves in the mouth. |
| | 1 | The sponge cake has a strongly glutinous texture and turns into a dumpling in |
| | | the mouth and extremely poorly dissolves in the mouth. |
| Flavor | 5 | The sponge cake has a sweet and favorable flavor and also has an excellent |
| | | taste. |
| | 4 | The sponge cake has a sweet flavor and also has a nearly excellent taste. |
| | 3 | The sponge cake has some sweet flavor and also has a slightly good taste. |
| | 2 | The sponge cake has almost no sweet flavor and almost no good taste. |
| | 1 | The sponge cake has no sweet flavor and no good taste. |

TABLE 11
Results

| | | Compar- | Compar- | | |
|---|---|---|---|---|---|
| | | ative | ative | | |
| | Control | example 3 | example 4 | Example 3 | Example 4 |
| Shape | 4 | 4 | 4 | 4 | 4 |
| Baked color | 4 | 4 | 4 | 4 | 3 |
| Texture | 3 | 3 | 4 | 4 | 5 |
| Property of | 3 | 3 | 3 | 4 | 5 |
| sweetly | | | | | |
| dissolving | | | | | |
| in the mouth | | | | | |
| Flavor | 4 | 4 | 4 | 4 | 4 |

The obtained sponge cake was comparable to an ordinary product with respect to shape, inner part, and outer appearance, had a cross-section that was finely grained and had fine air bubbles in a uniformly and neatly arranged state, and had a moist and soft texture and sweetly dissolved in the mouth.

In the case of a bakery product obtained using sucrose in a large amount, an isomerized liquid sugar lacks robustness as compared with sucrose. However, the bakery product obtained using a rare sugar-containing isomerized sugar syrup showed a result comparable to that of the bakery product obtained using sucrose with respect also to robustness.

Further, the sponge cake of Example 4 was evaluated as “3” in terms of baked color, which is because when a rare sugar is added, there is a tendency that a baked color becomes slightly darker as compared with the case where a rare sugar is not added. Accordingly, it is found that in the case where a baked color is desired to be dark, a rare sugar may be added in an appropriately amount.

Subsequently, by using a rare sugar-containing isomerized sugar syrup obtained by utilizing fructose as a raw material for producing the rare sugar-containing isomerized sugar syrup and changing the isomerization reaction time and the alkali concentration to longer and higher, respectively, than described above, the following study was performed. The thus obtained sugar liquid was analyzed, and the peak area ratios corresponding to respective sugars were approximately as follows: D-glucose:D-fructose:D-psicose:other rare sugars=22:34:16:10.

### EXAMPLES 5 TO 7

By using wheat flour and an isomerized sugar syrup (Comparative example 5) or D-psicose (Example 5) or D-psicose and D-allose (Example 6) or a rare sugar-containing isomerized sugar syrup (Example 7), English-type plain bread was produced by a straight dough method according to the following compositional ratios. The compositional ratios are shown in Table 12, and the production conditions are shown in Table 13. The obtained English-type plain bread was evaluated according to the above-described evaluation criteria shown in Table 3, and the evaluation results are shown in Table 14.

TABLE 12
Compositional ratios for plain bread

| | | Compar- | | | |
|---|---|---|---|---|---|
| | | ative | Example | Example | Example |
| Raw material | Control | example 5 | 5 | 6 | 7 |
| Hard wheat flour*¹ | 100 | 100 | 100 | 100 | 100 |
| Yeast*² | 2 | 2 | 2 | 2 | 2 |
| Yeast food*³ | 0.1 | 0.1 | 0.1 | 0.1 | 0.1 |
| Water | 73 | 70 | 70 | 70 | 70 |
| Sucrose | 3 | 3 | 3 | 3 | 3 |
| Fujifructo F-100 | — | 10 | — | — | — |
| D-psicose | — | — | 10 | — | — |
| D-psicose + D-allose | — | — | — | 10 | — |
| Rare sugar-containing | — | — | — | — | 10 |
| isomerized sugar syrup | | | | | |
| Salt | 2 | 2 | 2 | 2 | 2 |
| Skim milk powder*⁴ | 2 | 2 | 2 | 2 | 2 |
| Shortening*⁵ | 5 | 5 | 5 | 5 | 5 |

*¹ to ⁵The product names are the same as those shown in Table 1.

TABLE 13

Production conditions
Temperature of dough after completion of kneading: 27 to 28° C.
Fermentation time: 80 minutes, after punching, 30 minutes
Floor time: 20 minutes
Division: 275 g × 2
Bench time: 20 minutes
Final proof: 60 minutes
Baking temperature: upper heat: 180° C., lower heat: 205° C.
Baking time: 28 minutes

TABLE 14
Results

| | | Comparative | Example | Example | Example |
|---|---|---|---|---|---|
| | Control | example 5 | 5 | 6 | 7 |
| Shape | 4 | 4 | 4 | 4 | 4 |
| Flavor | 3 | 3 | 3 | 4 | 5 |
| Moistness | 3 | 3 | 4 | 5 | 5 |
| Softness | 3 | 3 | 3 | 4 | 5 |
| Property of | 3 | 2 | 3 | 3 | 4 |
| sweetly | | | | | |
| dissolving | | | | | |
| in the mouth | | | | | |

The obtained English-type plain bread loaves of Examples 5 to 7 were comparable to an ordinary product (control) with respect to shape, inner part, and outer appearance, and had a moist and soft texture and sweetly disolved in the mouth. In particular, it was confirmed that the plain bread of Example 6 in which D-psicose and D-allose were blended had a higher effect of improving texture and taste than the plain bread of Example 5 in which D-psicose was blended alone, and the plain bread of Example 7 in which the rare sugar-containing isomerized sugar syrup was blended had a further higher effect of improving texture and taste. From these results, it was presumed that not only an effect of D-psicose alone, but also a synergistic effect thereof with other rare sugars (including unidentified rare sugars) or a synergistic effect thereof with an isomerized sugar syrup is manifested.

Further, a study was performed by blending starch syrup or a sugar alcohol, both of which is generally said to impart moistness, however, the case where a rare sugar-containing isomerized sugar syrup was used showed a favorable result that the resulting product had a more moist texture than the case where the starch syrup or the sugar alcohol was used.

The present invention provides a new means, in response to the needs of consumers who demand a new type of food free of stereotype or a food which has an unprecedented texture or a further more improved texture or flavor, of using a rare sugar which is used in a variety of applications (for example, for restriction of calorie intake in the case of obesity or the like, for suppression of increase in blood glucose level due to a disease such as diabetes, etc.) such as a diet sweetener, and has a characteristic as “a low-calorie sweetener”, particularly D-psicose and/or D-allose in a bakery product.

1. A method of producing a bakery product, characterized by using raw material flour obtained by blending a rare sugar or a rare sugar-containing isomerized sugar syrup in the production of a bakery product using cereal flour as a main raw material, thereby imparting softness, moistness, and a property of sweetly dissolving in the mouth to the produced bakery product.

2. The method of producing a bakery product according to claim 1, wherein the rare sugar-containing isomerized sugar syrup or the rare sugar is blended in an amount of from 0.1 to 100 parts by mass based on 100 parts by mass of the main raw material flour.

3. The method of producing a bakery product according to claim 1, wherein the rare sugar-containing isomerized sugar syrup contains sugars other than D-glucose and D-fructose in an amount of less than 60% by mass, and is obtained by isomerizing one or more of the members selected from the group consisting of D-glucose, D-fructose, and an isomerized corn syrup with 0.005 mol/l or more of an alkali.

4. The method of producing a bakery product according to claim 1, wherein the rare sugar is at least D-psicose and/or D-allose.

5. The method of producing a bakery product according to claim 1, wherein the bakery product includes a step of assimilating a sugar by yeast.

6. The method of producing a bakery product according to claim 1, wherein the bakery product is plain bread.

7. A bakery product produced by the production method according to claim 1, which has softness, and moistness, and a property of sweetly dissolving in the mouth.
